(19) United States
(12) Patent Application Publication
(10) Pub. No.: US 2022/0355547 A1
(43) Pub. Date: Nov. 10, 2022

(54) SELECTIVE LAYER DEPOSITION BASED ADDITIVE MANUFACTURING SYSTEM USING LASER NIP HEATING

(71) Applicant: Evolve Additive Solutions, Inc., Minnetonka, MN (US)

(72) Inventor: J. Samuel Batchelder, Somers, NY (US)

(21) Appl. No.: 17/622,553

(22) PCT Filed: Jun. 30, 2020
(86) PCT No.: PCT/US2020/040316

§ 371 Date: Dec. 23, 2021

Related U.S. Application Data
(60) Provisional application No. 62/870,446, filed on Jul. 3, 2019.

(51) Int. Cl. B29C 64/268; B29C 64/153; B29C 64/245; B29C 64/218

(52) U.S. Cl. CPC B29C 64/268; B29C 64/153; B29C 64/245; B29C 64/218; B33Y 10/00

(57) ABSTRACT

Disclosed are selective layer deposition based additive manufacturing systems and methods for printing a 3D part. Layers of a powder material are developed using one or more electrostatography-based engines. The layers are transferred for deposition on a part build surface. One or more lasers are used to heat a region of the part build surface and a developed layer near the nip roller entrance. The developed layer is then pressed into the part build surface.

This application is being filed as a PCT International Patent application on Jun. 30, 2020, in the name of Evolve Additive Solutions, Inc., a U.S. national corporation, applicant for the designation of all countries, and J. Samuel Batchelder, a U.S. Citizen, inventor for the designation of all countries, and claims priority to U.S. Provisional Patent Application No. 62/870,446 filed Jul. 3, 2019, the contents of which are herein incorporated by reference in its entirety.

### BACKGROUND

The present disclosure relates to systems and methods for additive manufacturing of three-dimensional (3D) parts, and more particularly, to additive manufacturing systems and processes for building 3D parts and their support structures.

Additive manufacturing systems are used to build 3D parts from digital representations of the 3D parts (e.g., AMF and STL format files) using one or more additive manufacturing techniques. Examples of commercially available additive manufacturing techniques include extrusion-based techniques, ink jetting, selective laser sintering, powder/binder jetting, electron-beam melting, and stereolithographic processes. For each of these techniques, the digital representation of the 3D part is initially sliced into multiple horizontal layers. For each sliced layer, a tool path is then generated, which provides instructions for the particular additive manufacturing system to form the given layer.

In an electrophotographic 3D printing process, each slice of the digital representation of the 3D part and its support structure is printed or developed using an electrophotographic engine. The electrophotographic engine uses charged powder materials that are formulated for use in building a 3D part (e.g., a polymeric toner material). The electrophotographic engine typically uses a support drum that is coated with a photoconductive material layer, where latent electrostatic images are formed by electrostatic charging following image-wise exposure of the photoconductive layer by an optical source. The latent electrostatic images are then moved to a developing station where the polymeric toner is applied to charged areas, or alternatively to discharged areas of the photoconductive insulator to form the layer of the charged powder material representing a slice of the 3D part. The developed layer is transferred to a transfer medium, from which the layer is transfused to previously printed layers with heat and pressure to build the 3D part.

In addition to the aforementioned commercially available additive manufacturing techniques, a novel additive manufacturing technique has emerged, where particles are first selectively deposited in an imaging process, forming a layer corresponding to a slice of the part to be made; the layers are then bonded to each other, forming a part. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a developing station where toner is applied to charged areas of the photoconductive insulator to form visible images. The formed toner images are then transferred to substrates (e.g., printing paper) and affixed to the substrates with heat or pressure.

To transfuse each layer from the transfer medium to the part build surface, both of the part build surface and the layer on the transfer medium are typically pre-heated before a pressing component, for example in the form of a nip roller, applies pressure to transfer the layer to the part build surface. If the part build surface and/or part are heated too soon, they may cool more than a desired amount prior to pressure being applied by the part build surface. Another problem is that the part build surface and the layer to be transferred to should not be heated to temperatures that introduce degradation of the toner material. Further, some temperatures below degradation temperatures may still result in overly elongated parts or other undesirable results. Controlling the temperatures of the part build surface and the layer on the transfer medium to improve the transfusion process presents numerous challenges.

### SUMMARY

Aspects of the present disclosure are directed toward additive manufacturing systems and methods for printing three-dimensional (3D) structures. In one exemplary method embodiment, layers of a powder material are developed using at least one electrostatographic engine. The developed layers are transferred from the at least one electrostatographic engine to a transfer medium. One or more lasers is used to emit optical energy in a first band of wavelengths to apply optical energy in a region proximate a transfuse roller nip. At least one pyrometer is used to receive emissions from a surface in the region proximate the transfuse roller nip over a second band of wavelengths, distinct from the first band of wavelengths, and to convert the received emissions over the second band of wavelengths into temperature indicative outputs. A wavelength selective device, positioned between the at least one pyrometer and the transfuse roller nip, is used to allow optical energy within the second band of wavelengths to be transmitted from the transfuse roller nip to the at least one pyrometer while constraining optical energy within the first band of wavelengths from being received by the pyrometer. Optical energy from at least one laser is controlled responsive to the temperature indicative outputs of the at least one pyrometer. Once the developed layer is heated by the laser, the transfuse roller is used to press the developed layers on the transfer medium into contact with the part build surface to form a new part build surface.

In an aspect of some embodiments, using the at least one pyrometer to receive emissions from the surface in the region of the transfuse roller nip over the second band of wavelengths further comprises using a first pyrometer oriented to receive emissions from the part build surface and a second pyrometer oriented to receive emissions from a developed layer on the transfer medium. Controlling the at least one laser responsive to the temperature indicative outputs of the at least one pyrometer further comprises controlling the optical energy output of at least one laser based upon a comparison of the temperature indicative outputs, or corresponding temperatures or data, from the first and second pyrometers.

In an aspect of some embodiments, controlling the optical energy output of at least one laser responsive to the temperature indicative outputs of the at least one pyrometer further comprises controlling the optical energy emitted from at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part, where the distance xₕ is determined using the relationship:

$${x}_{h} = \frac{{v}_{b} {λ}_{z}^{2}}{{κ}_{p}} .$$

In an aspect of some embodiments, a selective layer deposition based additive manufacturing system is provided for printing a three-dimensional part. The additive manufacturing system comprises an electrostatographic imaging engine configured to develop an imaged layer of a thermoplastic-based powder, a movable build platform configured to support a 3D part having a part build surface, and a transfer medium configured to receive the imaged layer from the imaging engine, and to convey the received imaged layer. A transfuse roller transfusion element of the system is configured to transfer the imaged layer conveyed by the transfer medium onto the movable build platform by pressing the imaged layer between the transfer medium and the part build surface at a transfuse roller nip. At least one optical energy emitter, for example one or more lasers, is configured to utilize optical energy emissions in a first band of wavelengths to apply thermal energy in a region of the transfuse roller nip. At least one pyrometer of the system is configured to receive emissions from a surface in the region proximate the transfuse roller nip over a second band of wavelengths, distinct from the first band of wavelengths, and to convert the received emissions over the second band of wavelengths into temperature indicative outputs. A wavelength selective device is positioned between the at least one pyrometer and the transfuse roller nip and configured to allow optical energy within the second band of wavelengths to be transmitted from the transfuse roller nip to the at least one pyrometer while constraining optical energy within the first band of wavelengths from being received by the pyrometer. The system includes a controller configured to control the at least one radiant heater responsive to the temperature indicative outputs of the at least one pyrometer.

In an aspect of some embodiments where the at least one optical energy emitter comprises at least one laser, the at least one laser transmits emissions in the first band of wavelengths to apply optical energy to the part build surface and imaged layer in the region of the transfuse roller nip.

In an aspect of some embodiments, a mount is coupled to the at least one pyrometer and configured to orient the at least one pyrometer toward the transfuse roller nip.

In an aspect of some embodiments, the at least one pyrometer includes a first pyrometer and a second pyrometer, the first pyrometer oriented to receive emissions from the part build surface and the second pyrometer oriented to receive emissions from the imaged layer. In some embodiments, the controller is configured to control the optical energy output of the at least one laser based upon a comparison of the temperature indicative outputs from the first and second pyrometers.

In an aspect of some embodiments, the system includes at least one laser steering mechanism coupled to the at least one laser and configured to steer the at least one laser under the control of the controller to heat the imaged layer and the part build surface to approximately the same temperature.

In an aspect of some embodiments, the at least one laser includes at least one laser bar.

In an aspect of some embodiments, the controller is configured to control the optical energy output of at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part. The distance xₕ before the transfuse nip roller can be determined using the relationship:

$${x}_{h} = \frac{{v}_{b} {λ}_{z}^{2}}{{κ}_{p}} .$$

In an aspect of some embodiments, the system further includes a fast axis collimator lens positioned between the laser and the transfuse roller nip, and a cylindrical lens positioned between the fast axis collimator lens and the transfuse roller nip.

In an aspect of some embodiments, a selective layer deposition based additive manufacturing system is provided for printing a three-dimensional part. The additive manufacturing system comprises an electrostatographic imaging engine configured to develop an imaged layer of a thermoplastic-based powder, a movable build platform configured to support a 3D part having a part build surface, and a transfer medium configured to receive the imaged layer from the imaging engine, and to convey the received imaged layer. A transfuse roller transfusion element of the system is configured to transfer the imaged layer conveyed by the transfer medium onto the movable build platform by pressing the imaged layer between the transfer medium and the part build surface at a transfuse roller nip. At least one laser is configured to emit optical energy in a first band of wavelengths to apply optical energy in a region proximate the transfuse roller nip. A controller of the system is configured to control the optical energy output of the at least one laser to heat the part build surface and imaged layer in the region proximate the transfuse roller nip.

In an aspect of some embodiments, the controller is configured to control the optical energy output of the at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part. In some embodiments, the distance xₕ is determined using the relationship:

$${x}_{h} = \frac{{v}_{b} {λ}_{z}^{2}}{{κ}_{p}} .$$

In an aspect of some embodiments, the system further includes a fast axis collimator lens positioned between the at least one laser and the transfuse roller nip, and a cylindrical lens positioned between the fast axis collimator lens and the transfuse nip roller.

In an aspect of some embodiments, the system includes at least one pyrometer configured to receive emissions from a surface in the region of the transfuse roller nip over a second band of wavelengths, distinct from the first band of wavelengths, and to convert the received emissions over the second band of wavelengths into temperature indicative outputs. A wavelength selective device is positioned between the at least one pyrometer and the transfuse roller nip and configured to allow optical energy within the second band of wavelengths to be transmitted from the transfuse roller nip to the at least one pyrometer while constraining optical energy within the first band of wavelengths from being received by the pyrometer. The controller is configured to control the at least one laser as a function of the temperature indicative outputs from the at least one pyrometer.

In an aspect of some embodiments, the at least one pyrometer includes a first pyrometer and a second pyrometer, the first pyrometer oriented to receive emissions from the part build surface and the second pyrometer oriented to receive emissions from the imaged layer, wherein the controller is configured to control the at least one laser based upon a comparison of the temperature indicative outputs from the first and second pyrometers.

### Definitions

Unless otherwise specified, the following terms as used herein have the meanings provided below:

The term “copolymer” refers to a polymer having two or more monomer species, and includes terpolymers (i.e., copolymers having three monomer species).

The terms “at least one” and “one or more of” an element are used interchangeably, and have the same meaning that includes a single element and a plurality of the elements, and may also be represented by the suffix “(s)” at the end of the element. For example, “at least one polyamide”, “one or more polyamides”, and “polyamide(s)” may be used interchangeably and have the same meaning.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

Unless otherwise specified, temperatures referred to herein are based on atmospheric pressure (i.e. one atmosphere).

The terms “about” and “substantially” are used herein with respect to measurable values and ranges due to expected variations known to those skilled in the art (e.g., limitations and variabilities in measurements).

### BRIEF DESCRIPTION OF THE DRAWINGS

FIG. 1 is a simplified diagram of an exemplary electrophotography-based additive manufacturing system for printing 3D parts and associated support structures, in accordance with embodiments of the present disclosure.

FIG. 2 is a schematic front view of electrophotographic engines, in accordance with exemplary embodiments of the present disclosure.

FIG. 3 is a schematic front view of an exemplary electrophotographic engine, which includes a transfer drum or belt, in accordance with exemplary embodiments of the present disclosure.

FIG. 4A is a schematic front view of an exemplary transfusion assembly in a system using laser heating in the performance of layer transfusion steps and without planishing in accordance with exemplary embodiments of the present disclosure.

FIG. 4B is a schematic front view of an exemplary transfusion assembly in a system using laser heating in the performance of layer transfusion steps and with planishing in accordance with exemplary embodiments of the present disclosure.

FIG. 5A is a plot illustrating an example of heating distance as a function of thermal diffusion depth.

FIG. 5B is a plot illustrating an example of thermal power required as a function of thermal depth.

FIG. 5C is a diagrammatic illustration of exemplary nip entrance geometry.

FIG. 5D is a plot illustrating an example of the nip entrance opening for heating as a function of thermal depth.

FIG. 5E is a plot illustrating an example of the tilt of a nip opening as a function of thermal depth.

FIG. 5F is a plot illustrating an example of required black body temperature of an infrared (IR) lamp as a function of thermal depth.

FIG. 6A is a diagrammatic perspective view of portions of an exemplary transfusion assembly using a laser heater.

FIGS. 6B and 6C are diagrammatic side and perspective views of a portion of the exemplary transfusion assembly of FIG. 6A using laser heating.

FIG. 6D is a diagrammatic side view of a portion of the exemplary transfusion assembly of FIG. 6A using laser heating with a Fast Axis Collimator (FAC) lens and a cylindrical lens in accordance with another embodiment.

FIG. 7 is a plot illustrating an example of silicon absorption coefficient as a function of wavelength.

FIGS. 8A-8C are plots illustrating exemplary temperature distributions as functions of position for lasers pointed too high, pointed too low, and pointed correctly.

FIGS. 9A and 9B are diagrammatic front views of portions of another transfusion assembly in a system using laser heating and a direct nip temperature measurement.

FIG. 10 is a flow chart of a method for printing a part in accordance with exemplary embodiments.

### DETAILED DESCRIPTION

Embodiments of the disclosure are described more fully hereinafter with reference to the accompanying drawings. Elements that are identified using the same or similar reference characters refer to the same or similar elements. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

As will further be appreciated by one of skill in the art, the present disclosure may be embodied as methods, systems, devices, and/or computer program products, for example. Accordingly, the present disclosure may take the form of an entirely hardware embodiment, an entirely software embodiment or an embodiment combining software and hardware aspects. The computer program or software aspect of the present disclosure may comprise computer readable instructions or code stored in a computer readable medium or memory. Execution of the program instructions by one or more processors (e.g., central processing unit), such as one or more processors of a controller, results in the one or more processors performing one or more functions or method steps described herein. Any suitable patent subject matter eligible computer-readable media or memory may be utilized including, for example, hard disks, CD-ROMs, optical storage devices, or magnetic storage devices. Such computer-readable media or memory do not include transitory waves or signals.

The computer-readable medium or memory mentioned herein, may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random axis memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As mentioned above, during an electrostatography-based 3D part additive manufacturing or printing operation, electrostatographic engines develop each layer of a 3D part out of charged powder materials (e.g., polymeric toners) using the electrostatographic process. Systems which perform such operations are sometimes referred to as selective layer deposition based additive manufacturing systems. A completed layer of the 3D part typically includes a part portion formed of part material by one electrophotographic engine that is transferred to a suitable transfer medium, such as a transfer belt or drum, and/or a support structure portion formed of support material by a different electrostatographic engine that is applied to the transfer medium in registration with the corresponding part portion. Alternatively, the part portion may be developed and transferred to the transfer medium in registration with a previously printed support structure portion on the transfer medium. Further, a plurality of layers can be imaged in a reverse order of printing and stacked one on top of the other on the transfer medium to form a stack of a selected thickness.

The transfer medium delivers the developed layers or the stack of layers to a transfusion assembly where a transfusion process is performed to form a 3D structure in a layer-by-layer manner, a stack-by-stack manner or a combination of individual layers and stacks of layers to form the 3D part and corresponding support structure. During the transfusion process, heat and pressure is applied to fuse the developed layers or stacks of layers to build surfaces of the 3D structure. After printing of the 3D structure is completed, the support structures can then be dissolved or disintegrated in an aqueous solution or dispersion to reveal the completed 3D part.

While the present disclosure can be utilized with any electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

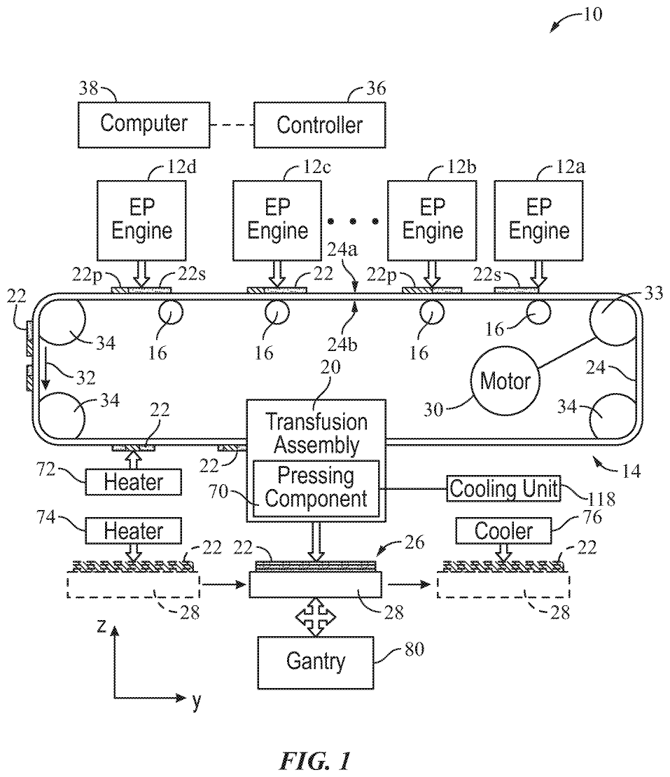

FIG. 1 is a simplified diagram of an exemplary electrophotography-based additive manufacturing system 10 for printing 3D parts and associated support structures in a layer-by-layer manner, in accordance with embodiments of the present disclosure. While illustrated as printing 3D parts and associated support structures in a layer-by-layer manner, the system 10 can also be used to form stacks of layers and transfuses the stacks to form the 3D parts and associated support structures.

As shown in FIG. 1, system 10 includes one or more electrophotographic (EP) engines, generally referred to as 12, such as EP engines 12a-d, a transfer assembly 14, at least one biasing mechanism 16, and a transfusion assembly 20. Examples of suitable components and functional operations for system 10 include those disclosed in Hanson et al., U.S. Pat. Nos. 8,879,957 and 8,488,994, and in Comb et al., U.S. Publication Nos. 2013/0186549 and 2013/0186558.

The EP engines 12 are imaging engines for respectively imaging or otherwise developing completed layers of the 3D part, which are generally referred to as 22, of the charged powder part and support materials. The charged powder part and support materials are each preferably engineered for use with the particular architecture of the EP engines 12. In some embodiments, at least one of the EP engines 12 of the system 10, such as EP engines 12a and 12c, develops layers of the support material to form the support structure portions 22s of a layer 22, and at least one of the EP engines 12, such as EP engines 12b and 12d, develops layers of the part material to form the part portions 22p of the layer 22. The EP engines 12 transfer the formed part portions 22p and the support structure portions 22s to a transfer medium 24. In some embodiments, the transfer medium is in the form of a transfer belt, as shown in FIG. 1. The transfer medium (such as belt 24) may take on other suitable forms in place of, or in addition to, the transfer belt, such as a transfer drum. Accordingly, embodiments of the present disclosure are not limited to the use of transfer mediums in the form of the transfer belt 24.

In some embodiments, the system 10 includes at least one pair of the EP engines 12, such as EP engines 12a and 12b, which cooperate to form completed layers 22. In some embodiments, additional pairs of the EP engines 12, such as EP engines 12c and 12d, may cooperate to form other layers 22.

In some embodiments, each of the EP engines 12 that is configured to form the support structure portion 22s of a given layer 22 is positioned upstream from a corresponding EP engine 12 that is configured to form the part portion 22p of the layer 22 relative to the feed direction 32 of the transfer belt 24. Thus, for example, EP engines 12a and 12c that are each configured to form the support structure portions 22s are positioned upstream from their corresponding EP engines 12b and 12d that are configured to form the part portions 22p relative to the feed direction 32 of the transfer belt 24, as shown in FIG. 1. In alternative embodiments, this arrangement of the EP engines 12 may be reversed such that the EP engines that form the part portions 22p may be located upstream from the corresponding EP engines 12 that are configured to form the support structure portions 22s relative to the feed direction 32 of the transfer belt 24. Thus, for example, the EP engine 12b may be positioned upstream from the EP engine 12a, and the EP engine 12d may be positioned upstream of the EP engine 12c relative to the feed direction 32 of the transfer belt 24.

As discussed below, the developed layers 22 are transferred to a transfer medium 24 of the transfer assembly 14, which delivers the layers 22 to the transfusion assembly 20. The transfusion assembly 20 operates to build a 3D structure 26, which includes the 3D part 26p, support structures 26s and/or other features, in a layer-by-layer manner by transfusing the layers 22 together on a build platform 28.

In some embodiments, the transfer medium includes a belt 24, as shown in FIG. 1. Examples of suitable transfer belts for the transfer medium (such as belt 24) include those disclosed in Comb et al. (U.S. Publication Nos. 2013/0186549 and 2013/0186558). In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The exemplary transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the layers 22, and other components.

System 10 also includes a controller 36, which represents one or more processors that are configured to execute instructions, which may be stored locally in memory of the system 10 or in memory that is remote to the system 10, to control components of the system 10 to perform one or more functions described herein. In some embodiments, the processors of the controller 36 are components of one or more computer-based systems. In some embodiments, the controller 36 includes one or more control circuits, microprocessor-based engine control systems, one or more programmable hardware components, such as a field programmable gate array (FPGA), and/or digitally-controlled raster imaging processor systems that are used to control components of the system 10 to perform one or more functions described herein. In some embodiments, the controller 36 controls components of the system 10 in a synchronized manner based on printing instructions received from a host computer 38 or from another location, for example.

In some embodiments, the controller 36 communicates over suitable wired or wireless communication links with the components of the system 10. In some embodiments, the controller 36 communicates over a suitable wired or wireless communication link with external devices, such as the host computer 38 or other computers and servers, such as over a network connection (e.g., local area network (LAN) connection), for example.

In some embodiments, the host computer 38 includes one or more computer-based systems that are configured to communicate with the controller 36 to provide the print instructions (and other operating information). For example, the host computer 38 may transfer information to the controller 36 that relates to the sliced layers of the 3D parts and support structures, thereby allowing the system 10 to print the layers 22 and form the 3D part including any support structures in a layer-by-layer manner. As discussed in greater detail below, in some embodiments, the controller 36 also uses signals from one or more sensors to assist in properly registering the printing of the part portion 22p and/or the support structure portion 22s with a previously printed corresponding support structure portion 22s or part portion 22p on the belt 24 to form the individual layers 22.

The components of system 10 may be retained by one or more frame structures. Additionally, the components of system 10 may be retained within an enclosable housing that prevents components of the system 10 from being exposed to ambient light during operation.

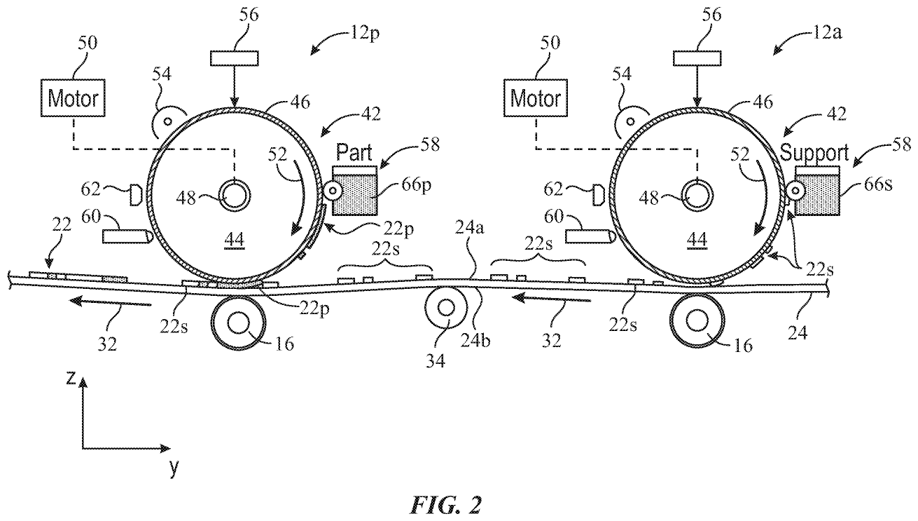

FIG. 2 is a schematic front view of the EP engines 12a and 12b of the system 10, in accordance with exemplary embodiments of the present disclosure. In the shown embodiment, the EP engines 12a and 12b may include the same components, such as a photoconductor drum 42 having a conductive body 44 and a photoconductive surface 46. The conductive body 44 is an electrically-conductive body (e.g., fabricated from copper, aluminum, tin, or the like), that is electrically grounded and configured to rotate around a shaft 48. The shaft 48 is correspondingly connected to a drive motor 50, which is configured to rotate the shaft 48 (and the photoconductor drum 42) in the direction 52, as shown by an arrow at a substantially constant rate. While embodiments of the EP engines 12 are discussed and illustrated as utilizing a photoconductor drum 42, a belt having a conductive material, or other suitable bodies, may also be utilized in place of the photoconductor drum 42 and the conductive body 44.

The photoconductive surface 46 is a thin film extending around the circumferential surface of the conductive body 44 (shown as a drum but can alternatively be a belt or other suitable body), and is preferably derived from one or more photoconductive materials, such as amorphous silicon, selenium, zinc oxide, organic materials, and the like. As discussed below, the surface 46 is configured to receive latent-charged images of the sliced layers of a 3D part or support structure (or negative images), and to attract charged particles of the part or support material to the charged or discharged image areas, thereby creating the layers 22 of the 3D part 26p, or support structure 26s.

As further shown, each of the exemplary EP engines 12a and 12b also includes a charge inducer 54, an imager 56, a development station 58, a cleaning station 60, and a discharge device 62, each of which may be in signal communication with the controller 36. The charge inducer 54, the imager 56, the development station 58, the cleaning station 60, and the discharge device 62 accordingly define an image-forming assembly for the surface 46, while the drive motor 50 and the shaft 48 rotate the photoconductor drum 42 in the direction 52.

The EP engines 12 use the charged particle material (e.g., polymeric or thermoplastic toner), generally referred to herein as 66, to develop or form the layers 22. In some embodiments, the image-forming assembly for the surface 46 of the EP engine 12a is used to form support structure portions 22s of the support material 66s, where a supply of the support material 66s may be retained by the development station 58 (of the EP engine 12a) along with carrier particles. Similarly, the image-forming assembly for the surface 46 of the EP engine 12b is used to form part portions 22p of the part material 66p, where a supply of the part material 66p may be retained by the development station 58 (of the EP engine 12b) along with carrier particles.

The charge inducer 54 is configured to generate a uniform electrostatic charge on the surface 46 as the surface 46 rotates in the direction 52 past the charge inducer 54. Suitable devices for the charge inducer 54 include corotrons, scorotrons, charging rollers, and other electrostatic charging devices.

The imager 56 is a digitally-controlled, pixel-wise light exposure apparatus configured to selectively emit electromagnetic radiation toward the uniform electrostatic charge on the surface 46 as the surface 46 rotates in the direction 52 past the imager 56. The selective exposure of the electromagnetic radiation to the surface 46 is directed by the controller 36, and causes discrete pixel-wise locations of the electrostatic charge to be removed (i.e., discharged), thereby forming latent image charge patterns on the surface 46.

Suitable devices for the imager 56 include scanning laser (e.g., gas or solid state lasers) light sources, light emitting diode (LED) array exposure devices, and other exposure devices conventionally used in 2D electrophotography systems. In alternative embodiments, suitable devices for the charge inducer 54 and the imager 56 include ion-deposition systems configured to selectively directly deposit charged ions or electrons to the surface 46 to form the latent image charge pattern. In accordance with this embodiment, the charge inducer 54 may be eliminated. In some embodiments, the electromagnetic radiation emitted by the imager 56 has an intensity that controls the amount of charge in the latent image charge pattern that is formed on the surface 46. As such, as used herein, the term “electrophotography” can broadly be considered as “electrostatography,” or a process that produces a charge pattern on a surface. Alternatives also include such things as ionography.

Each development station 58 is an electrostatic and magnetic development station or cartridge that retains the supply of the part material 66p or the support material 66s, along with carrier particles. The development stations 58 may function in a similar manner to single or dual component development systems and toner cartridges used in 2D electrophotography systems. For example, each development station 58 may include an enclosure for retaining the part material 66p or the support material 66s, and carrier particles. When agitated, the carrier particles generate triboelectric charges to attract the powders of the part material 66p or the support material 66s, which charges the attracted powders to a desired sign and magnitude, as discussed below.

Each development station 58 may also include one or more devices for transferring the charged particles of the support material 66p or 66s to the surface 46, such as conveyors, fur brushes, paddle wheels, rollers, and/or magnetic brushes. For instance, as the surface 46 (containing the latent charged image) rotates from the imager 56 to the development station 58 in the direction 52, the charged part material 66p or the support material 66s is attracted to the appropriately charged regions of the latent image on the surface 46, utilizing either charged area development or discharged area development (depending on the electrophotography mode being utilized). This creates successive layers 22p or 22s on the surface 46 as the photoconductor drum 42 continues to rotate in the direction 52, where the successive layers 22p or 22s correspond to the successive sliced layers of the digital representation of the 3D part or support structure.

In some embodiments, the thickness of the layers 22p or 22s on the surface 46 depends on the charge of the latent image charge pattern on the surface. Thus, the thickness of the layers 22p or 22s may be controlled through the control of the magnitude of the charge in the pattern on the surface using the controller 36. For example, the controller 36 may control the thickness of the layers 22p or 22s by controlling the charge inducer 54, by controlling the intensity of the electromagnetic radiation emitted by the imager 56, or by controlling the duration of exposure of the surface 46 to the electromagnetic radiation emitted by the imager 56, for example.

The successive layers 22p or 22s are then rotated with the surface 46 in the direction 52 to a transfer region in which layers 22p or 22s are successively transferred from the photoconductor drum 42 to the belt 24 or another transfer medium, as discussed below. While illustrated as a direct engagement between the photoconductor drum 42 and the belt 24, in some preferred embodiments, the EP engines 12a and 12b may also include intermediary transfer drums and/or belts, as discussed further below.

After a given layer 22p or 22s is transferred from the photoconductor drum 42 to the belt 24 (or an intermediary transfer drum or belt), the drive motor 50 and the shaft 48 continue to rotate the photoconductor drum 42 in the direction 52 such that the region of the surface 46 that previously held the layer 22p or 22s passes the cleaning station 60. The cleaning station 60 is a station configured to remove any residual, non-transferred portions of part or support material 66p or 66s. Suitable devices for the cleaning station 60 include blade cleaners, brush cleaners, electrostatic cleaners, vacuum-based cleaners, and combinations thereof.

After passing the cleaning station 60, the surface 46 continues to rotate in the direction 52 such that the cleaned regions of the surface 46 pass the discharge device 62 to remove any residual electrostatic charge on the surface 46, prior to starting the next cycle. Suitable devices for the discharge device 62 include optical systems, high-voltage alternating-current corotrons and/or scorotrons, one or more rotating dielectric rollers having conductive cores with applied high-voltage alternating-current, and combinations thereof.

The biasing mechanisms 16 are configured to induce electrical potentials through the belt 24 to electrostatically attract the layers 22s and 22p from the EP engines 12a and 12b to the belt 24. Because the layers 22s and 22p are each only a single layer increment in thickness at this point in the process, electrostatic attraction is suitable for transferring the layers 22s and 22p from the EP engines 12a and 12b to the belt 24. In some embodiments, the thickness of the layers 22p or 22s on the surface 24a of the belt 24 depends on the electrical potential induced through the belt by the corresponding biasing mechanism 16. Thus, the thickness of the layers 22p or 22s may be controlled by the controller 36 through the control of the magnitude of the electrical potential induced through the belt by the biasing mechanisms 16.

The controller 36 preferably controls the rotation of the photoconductor drums 42 of the EP engines 12a and 12b at the same rotational rates that are synchronized with the line speed of the belt 24 and/or with any intermediary transfer drums or belts. This allows the system 10 to develop and transfer the layers 22s and 22p in coordination with each other from separate developer images. In particular, as shown, each part of the layer 22p may be transferred to the belt 24 with proper registration with each support layer 22s to produce a combined part and support material layer, which is generally designated as layer 22. As can be appreciated, some of the layers 22 transferred to the layer transfusion assembly 20 may only include support material 66s, or may only include part material 66p, depending on the particular support structure and 3D part geometries and layer slicing.

In an alternative embodiment, the part portions 22p and the support structure portions 22s may optionally be developed and transferred along the belt 24 separately, such as with alternating layers 22s and 22p. These successive, alternating layers 22s and 22p may then be transferred to the layer transfusion assembly 20, where they may be transfused separately to print or build the structure 26 that includes the 3D part 26p, the support structure 26f, and/or other structures.

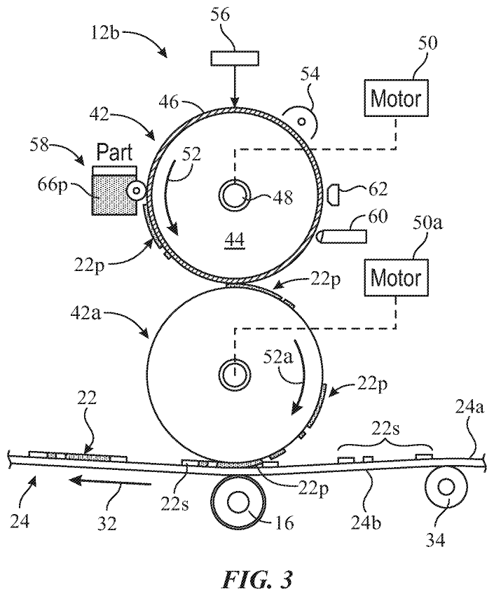

In a further alternative embodiment, one or both of the EP engines 12a and 12b may also include one or more transfer drums and/or belts between the photoconductor drum 42 and the belt or transfer medium (such as belt 24). For example, as shown in FIG. 3, the EP engine 12b may also include a transfer drum 42a that rotates in the direction 52a that opposes the direction 52, in which drum 42 is rotated, under the rotational power of motor 50a. The transfer drum 42a engages with the photoconductor drum 42 to receive the developed layers 22p from the photoconductor drum 42, and then carries the received developed layers 22p and transfers them to the belt 24.

The EP engine 12a may include the same arrangement of a transfer drum 42a for carrying the developed layers 22s from the photoconductor drum 42 to the belt 24. The use of such intermediary transfer drums or belts for the EP engines 12a and 12b can be beneficial for thermally isolating the photoconductor drum 42 from the belt 24, if desired.

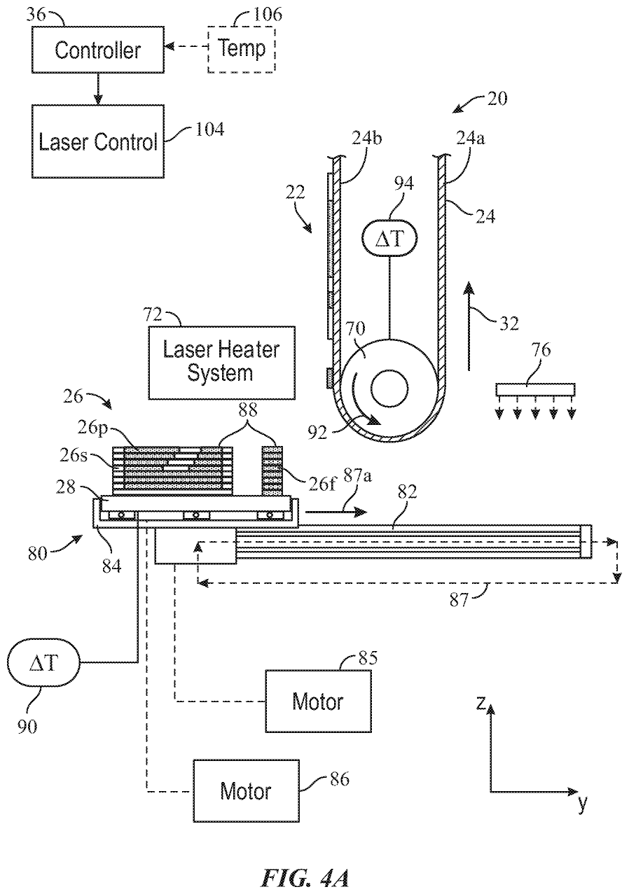

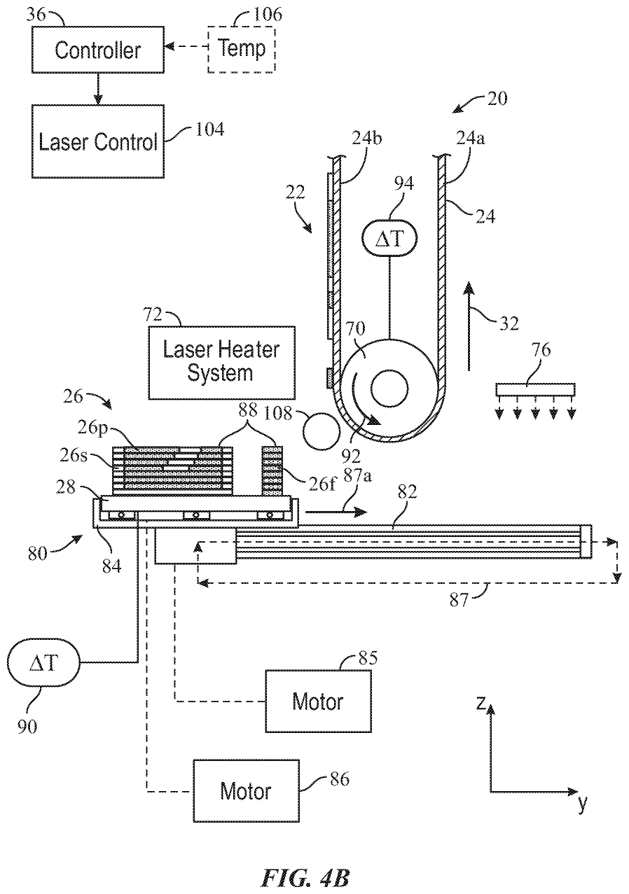

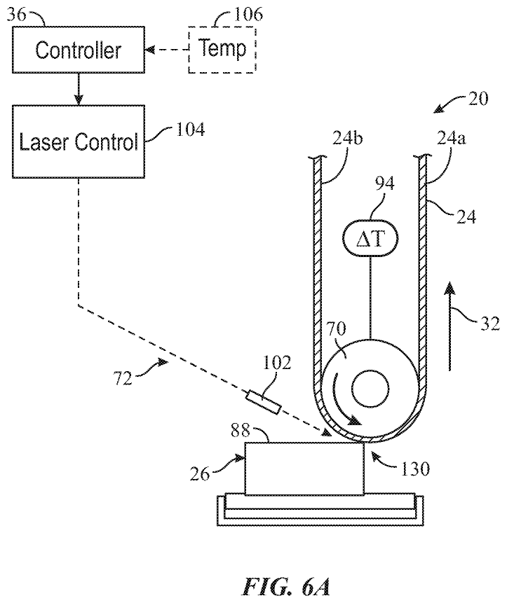

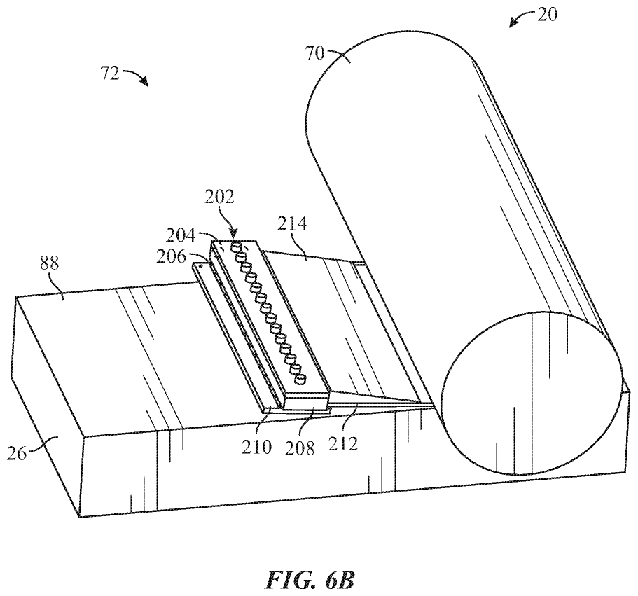

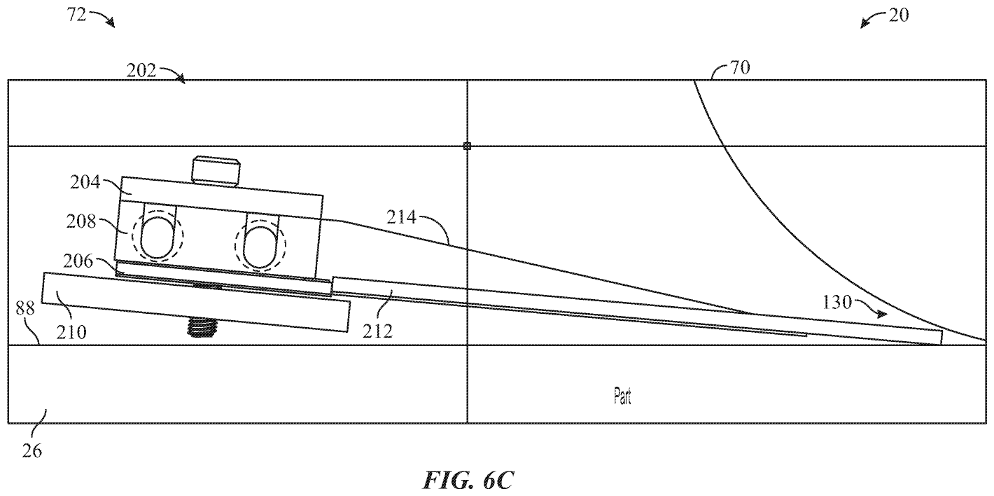

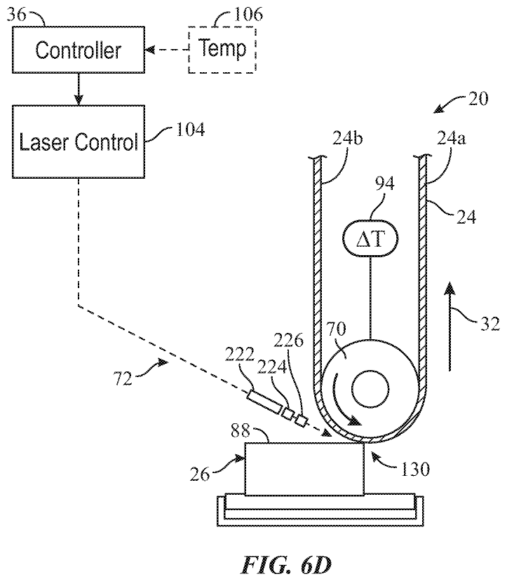

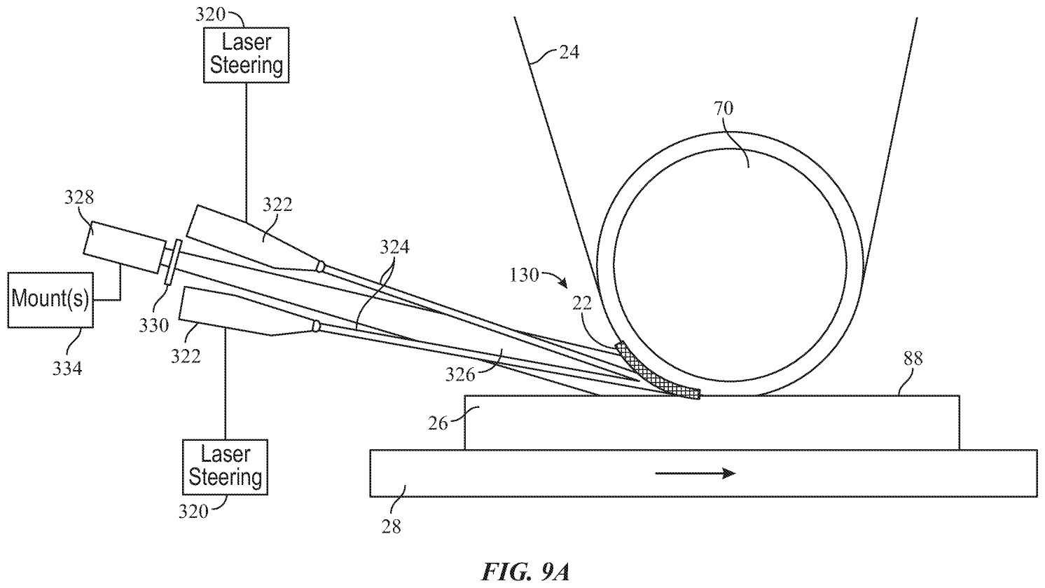

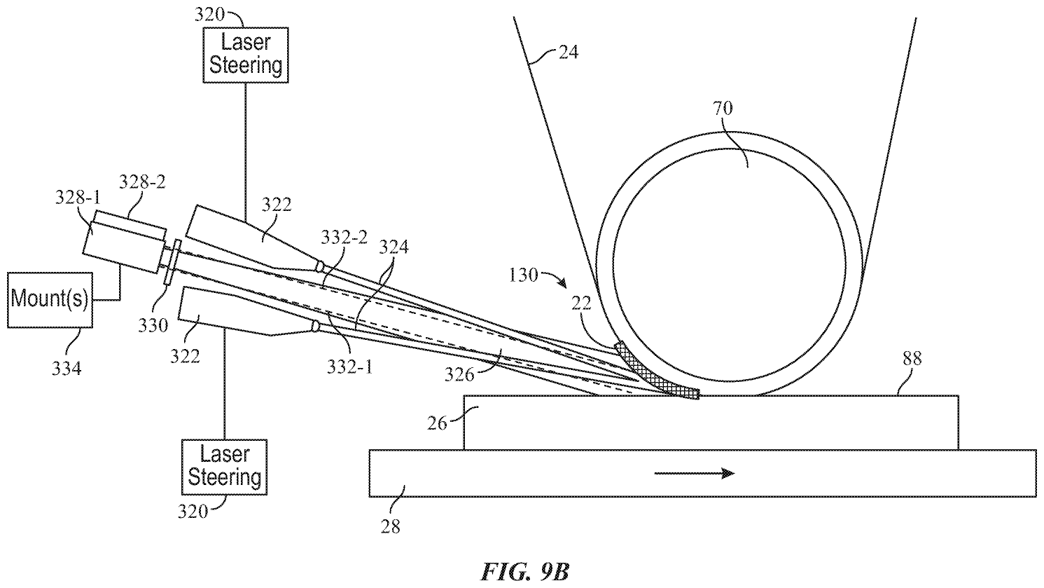

FIGS. 4A and 4B illustrate exemplary embodiments of the layer transfusion assembly 20 and further illustrate laser heating features in accordance with these exemplary embodiments. For instance, laser heating system 72 can include various types of lasers for heating a nip roller entrance, temperature measurement and feedback components 106 configured to provide real-time nip temperature feedback, and laser control circuitry 104, which can include or be embodied by program modules configuring controller 36. Such features are discussed further below in the general context of operation of exemplary transfusion assemblies shown in FIGS. 4A and 4B, as well as in the context of more specific embodiments shown in FIGS. 6A-6D and 9A-9B.

As shown in FIG. 4A, embodiments of the transfusion assembly 20 include the build platform 28, a pressing component (such as nip roller 70), laser heating system 72, and a post-transfusion cooler 76. The build platform 28 is a platform assembly or platen of system 10 that is configured to receive the heated combined layers 22 (or separate layers 22p and 22s) for printing the structure 26, which includes a 3D part 26p formed of the part portions 22p, and support structure 26s formed of the support structure portions 22s, in a layer-by-layer manner. In some embodiments, the build platform 28 may include removable film substrates (not shown) for receiving the printed layers 22, where the removable film substrates may be restrained against the build platform 28 using any suitable technique (e.g., vacuum, clamping or adhering).

The build platform 28 is supported by a gantry 80, or other suitable mechanism, which is configured to move the build platform 28 along the z-axis and the y-axis, as illustrated schematically in FIGS. 1, 4A and 4B, and optionally along the x-axis that is orthogonal to the y and z axes. In some embodiments, the gantry 80 includes a y-stage gantry 82 that is configured to move the build platform 28 along at least the y-axis, and an x-stage gantry 84 that is configured to move the build platform 28 along the x-axis. In some embodiments, the y-stage gantry 82 is configured to further move the build platform 28 along the z-axis. Alternatively, the gantry 80 may include a z-stage gantry that is configured to move the build platform along the z-axis. The y-stage gantry 82 may be operated by a motor 85, and the x-stage gantry 84 may be operated by a motor 86, based on commands from the controller 36. The motors 85 and 86 may each be any suitable actuator an electrical motor, a hydraulic system, a pneumatic system, piezoelectric, or the like.

In some embodiments, the y-stage gantry 82 supports the x-stage gantry 84, as illustrated in FIGS. 4A and 4B, or vice versa. In some embodiments, the y-stage gantry 82 is configured to move the build platform 28 and the x-stage gantry 84 along the z-axis and the y-axis. In some embodiments, the y-stage gantry 82 produces a reciprocating rectangular pattern where the primary motion is back-and-forth along the y-axis, as illustrated by broken lines 87 in FIG. 4A. While the reciprocating rectangular pattern is illustrated as a rectangular pattern with sharp axial corners (defined by arrows 87), y-stage gantry 82 may move the build platform 28 in a reciprocating rectangular pattern having rounded or oval corners, so long as the build platform 28 moves along the y-axis process direction (illustrated by arrow 87a) during the transfusion or pressing steps at the pressing component 70 described below. The controller 36 controls the y-stage gantry 82 to shift the location of a build surface 88, which is the top surface of the printed structure 26, along the y-axis and position the layers 22 in proper registration with the build surface 88 along the y-axis during the transfusion operation.

The x-stage gantry 84 is configured to move the build platform 28 along the x-axis relative to the y-stage gantry 82, thereby moving the build platform 28 and the printed structure 26 in perpendicular or lateral directions relative to the y-axis process direction of arrow 87a. The x-stage gantry 84 allows the controller 36 to shift the location of the build surface 88 of the structure 26 along the x-axis to position the layers 22 in proper registration with the build surface 88 along the x-axis during the transfusion operation.

In some embodiments, the build platform 28 is heated using a heating element 90 (e.g., an electric heater). The heating element 90 is configured to heat and maintain the build platform 28 at an elevated temperature that is greater than room temperature (25° C.), such as at a desired average part temperature of 3D part 26p and/or support structure 26s, as discussed in Comb et al., U.S. Publication Nos. 2013/0186549 and 2013/0186558. This allows the build platform 28 to assist in maintaining 3D part 26p and/or support structure 26s at this average part temperature. However, it must be noted that heating of build platform 28 is not required in all embodiments.

The pressing component (such as nip roller 70) is configured to press the layers 22 from the belt to the build surface 88 of the structure 26 and therefore, transfuse the layers 22 to the build surface 88. In some embodiments, the pressing component (such as nip roller 70) is configured to press each of the developed layers 22 on the belt 24 or other transfer medium into contact with the build surfaces 88 of the structure 26 on the build platform 28 for a dwell time to form the 3D structure 26 in a layer-by-layer manner.

The pressing component (such as nip roller 70) may take on any suitable form. In some exemplary embodiments, the pressing component (such as nip roller 70) is in the form of a nip roller, as shown in FIG. 4A. The pressing component (such as nip roller 70) can also be a pressing plate, such as discussed in Comb et al., in U.S. Pub. Nos. 2013/0186549 and 2013/0075033, which are each incorporated by reference in their entirety. In some exemplary embodiments, the pressing component (such as nip roller 70) includes the support of the belt 24 between pairs of rollers, such as discussed in Comb et al., in U.S. Pub. Nos. 2013/0186549 and 2013/0075033. The pressing component (such as nip roller 70) may also take on other suitable forms. Thus, while embodiments will be described below using the nip roller embodiment of the pressing component (such as nip roller 70), it is understood that embodiments of the present disclosure include the replacement of the nip roller with another suitable pressing component (such as nip roller 70).

FIG. 4B illustrates an embodiment of a system 10 using a planishing roller 108. Planishing rollers such as roller 108 serve to compact a layer to reduce voids, potentially to heat a layer to remove at least some moisture and solvents, and/or to create films that support tensile loading. A roller 108 presses the layer 22 between itself and the pressing component (such as nip roller 70) in this embodiment, but a separate planishing roller 108 and second roller could be used apart from the pressing component without departing from the scope of the disclosure. While a planishing roller can be used to reduce voids or pores, below described embodiments utilize lasers and methods of rapidly heating the top part layers at build surface 88 near a nip entrance to fully consolidate each layer at the time of transfer onto the build surface, and planishing therefore may not be required or provide sufficient additional benefit in some embodiments.

In some embodiments, the nip roller 70 is configured to rotate around a fixed axis with the movement of the belt 24. In particular, the nip roller 70 may roll against the rear surface 24b of the belt 24 in the direction of arrow 92, while the belt 24 rotates in the feed direction 32. In some embodiments, the pressing component (such as nip roller 70) includes a heating element 94 (such as an electric heater) that is configured to maintain the pressing component (such as nip roller 70) at an elevated temperature that is greater than room temperature (25° C.), such as at a desired transfer temperature for the layers 22.

In various embodiments, laser heating system 72 includes one or more laser emitters that are configured to heat either the part build surface 88 near the nip entrance, or to heat both of the part build surface and the layer 22, through the absorption of optical energy. The part build surface 88 and layer 22 to be deposited from belt 24 are heated to a temperature near an intended transfer temperature of the layer 22, such as at least a fusion temperature of the part material 66p and the support material 66s, just prior to reaching nip roller 70.

Post-transfusion cooler 76 is located downstream from nip roller 70 relative to the direction 87a in which the build platform 28 is moved along the y-axis by the y-stage gantry 82, and is configured to cool the transfused layers 22. The post-transfusion cooler 76 removes sufficient amount of heat to maintain the printed structure at a thermally stable average part temperature such that the part being printed does not deform due to heating or processing conditions during the transfusion process.

As mentioned above, in some embodiments, prior to printing the structure 26, the build platform 28 and the nip roller 70 may be heated to desired temperatures. For example, the build platform 28 may be heated to the average part temperature of 3D part 26p and support structure 26s (due to the close melt rheologies of the part and support materials). In comparison, the nip roller 70 may be heated to a desired transfer temperature for the layers 22 (also due to the close melt rheologies of the part and support materials).

As further shown in FIG. 4A, during operation, the y-stage gantry 82, or a combination of the y-stage gantry 82 and a z-stage gantry, may move the build platform 28 (with 3D part 26p and support structure 26s) in a broken line 87. For example, as the y-stage gantry 82 moves the build platform 28 along the y-axis in the direction 87a to move the part build surface along the nip entrance, the laser heater system 72 rapidly heats the build surfaces 88 of the 3D part 26p and support structure 26s to an elevated temperature which is below a thermal oxidation temperature of the material. The layer 22 is transfused by pressing the press component (nip roller 70) against the belt 24 to sandwich the layer 22 between the belt 24 and the part 26. This transfuses the layer 22 to the part structure 26 and fully consolidates the layer, substantially eliminating voids. A cooler 76 is used to rapidly cool the part surface to remove the heat energy added immediately prior to transfusion. For example, the cooler 76 can cool the part surface to a temperature sufficiently cool that it is substantially non-flowing, in one embodiment below a temperature at which the at the Young's Modulus sharply declines.

In general, the continued rotation of the belt 24 and the movement of the build platform 28 align the layer 22 with the build surfaces 88 of 3D part 26p and support structure 26s along the y-axis. The y-stage gantry 82 may move the build platform 28 along the y-axis at a rate that is synchronized with the rotational rate of the belt 24 in the feed direction 32 (i.e., the same directions and speed). This causes the rear surface 24b of the belt 24 to rotate around the nip roller 70 to nip the belt 24 and the layer 22 against the build surfaces 88 of the 3D part structure 26p and/or the support structure 26s at a pressing location or nip of the nip roller 70. This pressing of the laser heated layer 22 against the laser heated build surfaces 88 of the 3D part 26p and/or the support structure 26s at the location of the nip roller 70 transfuses a portion of the layer 22 below the nip roller 70 to the corresponding build surfaces 88 while fully consolidating the layer 22 to the build surface.

In some embodiments, a pressure that is applied to the layer 22 between the belt 24 and the build surfaces 88 of the 3D structure 26 during this pressing stage of the transfusion process is controlled by the controller 36 through the control of a pressing component roller bias mechanism. The pressing component bias mechanism controls a position of the build surfaces 88 relative to the nip roller 70 or belt 24 along the z-axis. For instance, when the pressing component (such as nip roller 70) is in the form of the nip roller, as the separation between the build surfaces 88 and the nip roller 70 or belt 24 is decreased along the z-axis, the pressure applied to the layer 22 increases, and as the separation between the build surfaces 88 and the nip roller 70 or belt 24 is increased along the z-axis, the pressure applied to the layer 22 decreases. In some embodiments, the pressing component bias mechanism includes the gantry 80 (e.g., z-stage gantry), which controls a position of the build platform 28 and the build surfaces 88 along the z-axis relative to the pressing component (such as nip roller 70) and the belt 24.

After rapid cooling using cooler 76 to remove the heat energy from the build surface and the most recent transferred layer, the y-stage gantry 82 may then actuate the build platform 28 downward, and move the build platform 28 back along the y-axis to a starting position along the y-axis, following the broken line 87. The build platform 28 desirably reaches the starting position, and the build surfaces 88 are properly registered with the next layer 22 using the gantry 80. The same process may then be repeated for each remaining layer 22 of 3D part 26p and support structure 26s.

After the part structure 26 is completed on the build platform 28, the structure 26 may be removed from the system 10 and undergo one or more operations to reveal the completed 3D part 26p. For example, the support structure 26s may be sacrificially removed from the 3D part structure 26p using an aqueous-based solution such as an aqueous alkali solution. Under this technique, the support structure 26s may at least partially dissolve or disintegrate in the solution separating the support structure 26s from the 3D part structure 26p in a hands-free manner. In comparison, the part structure 26p is chemically resistant to aqueous solutions including alkali solutions. This allows the use of an aqueous alkali solution for removing the sacrificial support 26s without degrading the shape or quality of the 3D part 26p. Furthermore, after the support structure 26s is removed, the 3D part structure 26p may undergo one or more additional processes, such as surface treatment processes.

Use of a laser heating system 72 to rapidly heat the part build surface 88 and layer 22 to be deposited onto the part build surface provides benefits which are difficult to achieve with conventional heaters such as infrared (IR) lamp heaters. To maximize the available reptation time when toner particles are first fused, the image (layer 22) and part surface 88 temperatures optimally peak at the transfuse nip entrance 130. The distance approaching the nip entrance over which heating occurs is set by the desired thermal diffusion depth λ_{z} and the belt speed v_{b}. If the new consolidated toner layer is z_{image} thick, and the part has a thermal diffusivity Kₚ, and the thermal diffusion distance should be 2 to 5 layers deep, then the following relationship applies:

2z_{image}<λ_{z}<5z_{image}

The heating distance in advance of the nip entrance is:

$${x}_{h} = \frac{{v}_{b} {λ}_{z}^{2}}{{κ}_{p}}$$

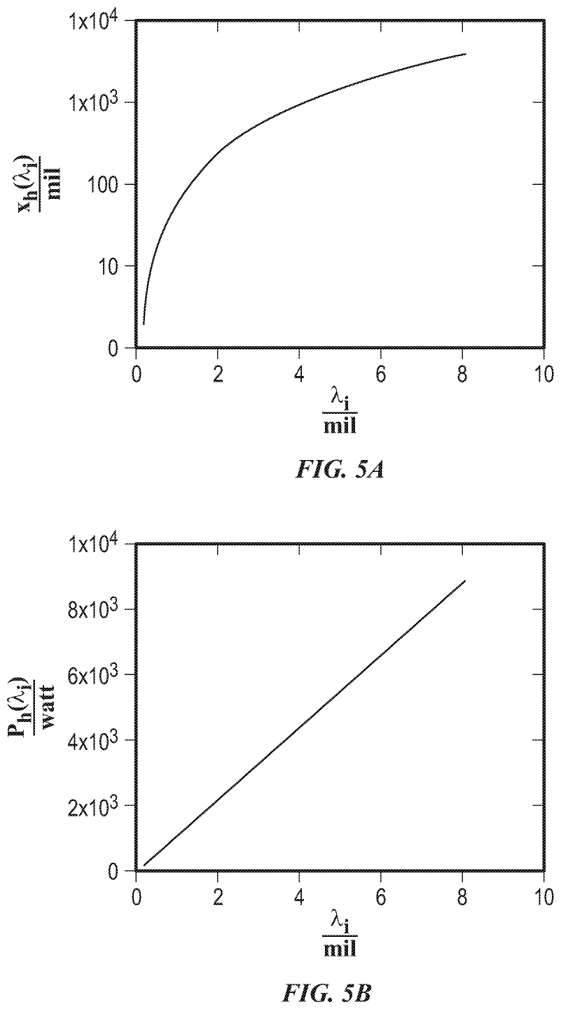

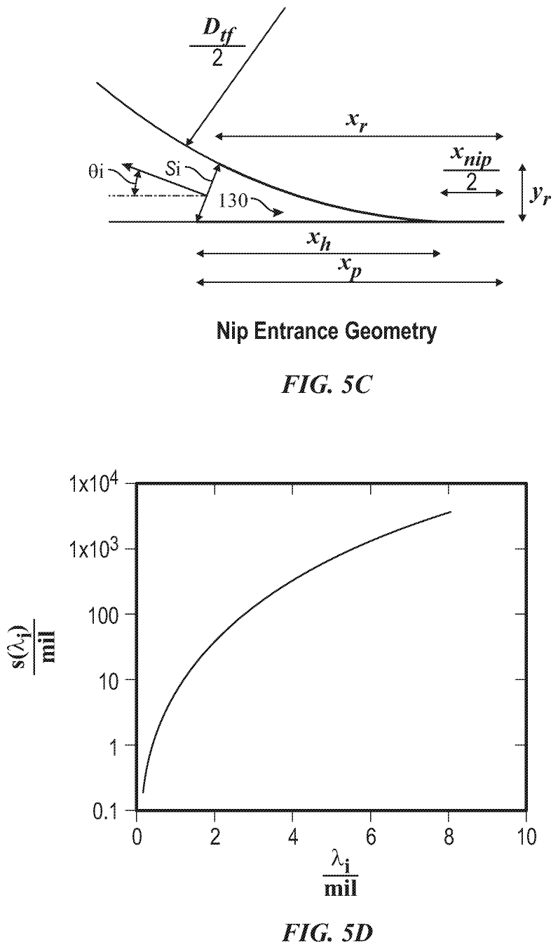

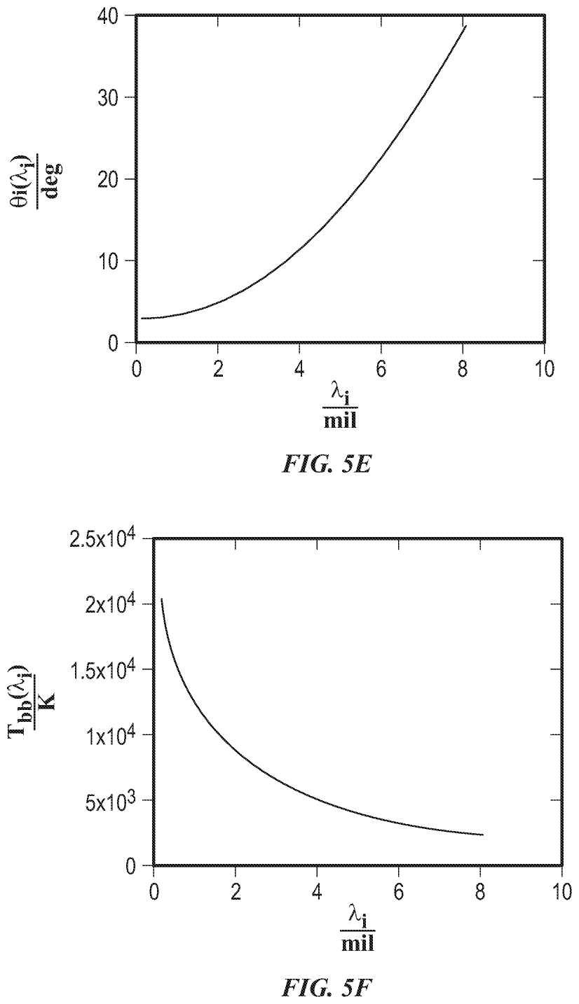

The thermal diffusion depth Aₓ is an important design variable. The plots of FIGS. 5A-5B and 5D-5F show design tradeoffs resulting from selecting a different thermal diffusion depth, such as the plot of FIG. 5A showing different heating distances xₕ, upstream of the nip entrance, required by a 12 ips (inches per second) system. The heating distances upstream of the nip entrance shown in FIG. 5A are plotted as a function of the thermal depth λ_{z}. For example, if Kₚ is 200 mil²/s, λ_{z} is 2.6 mils, and v_{b} is 12 ips, xₕ is 405 mils. An example depth λ_{z} of 2.6 mils is selected due to the fact that it is deep enough that the heat will only diffuse \sqrt{2} deeper in z by the nip exit, and due to the fact that it is several toner layers deep, so there will be some re-processing of buried layers.

Given a thermal conductivity Kₚ of 0.18 watt/m degC and a temperature rise ΔT of 200 C (assumed to be uniform in the heated layer) in both the image and the part surface, the required absorbed optical energy across that heating distance is as plotted in FIG. 5B. If the heated width W_{y} is 10 in, the required power is 2.8 Kwatt. FIG. 5C illustrates nip entrance geometry between the nip roller 70 and the part build surface 88. Suppose the transfuse roller has a diameter D_{tf} of 4 in and a compressed nip length of xₙᵢₚ of 0.4″. The nip entrance 130 will meet at an angle θₙᵢₚ, between the roller and the part build surface, represented by the equation:

$${θ}_{nip} = a sin ( \frac{{x}_{nip}}{{D}_{tf}} )$$

In this example, θₙᵢₚ is 5.7 degrees. The start of the heated surface of the part is xₕ+xₙᵢₚ/2 from the center plane of the transfuse roller, or 440 mils from the roller center. The start of the heated surface of the image or roller is displaced

$$\frac{{D}_{tf}}{2} ( sin ( {θ}_{nip} + \frac{2 {x}_{h}}{{D}_{tf}} ) , cos ( {θ}_{nip} ) - cos ( {θ}_{nip} - \frac{2 {x}_{h}}{{D}_{tf}} ) )$$

from an origin where the part surface meets a plane of symmetry of the transfuse roller, or (437 mil, 38 mil) in the example.

The nip entrance opening sᵢ becomes 81 mils in this example, and generally is defined by the following relationship (see plot of FIG. 5D showing the nip entrance opening as a function of thermal depth):

$${s}_{i} = \sqrt{{( {x}_{h} + \frac{{x}_{nip}}{2} - \frac{{D}_{tf}}{2} sin ( {θ}_{nip} + \frac{2 {x}_{h}}{{D}_{tf}} ) )}^{2} + {( \frac{{D}_{tf}}{2} ( cos ( {θ}_{nip} ) - cos ( {θ}_{nip} - \frac{2 {x}_{h}}{{D}_{tf}} ) ) )}^{2}}$$

The tilt angle θᵢ from horizontal of the nip entrance opening is defined by the relationship:

$${θ}_{i} = a tan ( \frac{{x}_{h} + \frac{{x}_{nip}}{2} - \frac{{D}_{tf}}{2} sin ( {θ}_{nip} + \frac{2 {x}_{h}}{{D}_{tf}} )}{\frac{{D}_{tf}}{2} ( cos ( {θ}_{nip} ) - cos ( {θ}_{nip} - \frac{2 {x}_{h}}{{D}_{tf}} ) )} )$$

In this example, the tilt angle is 6.2 deg. The tilt angle of the nip entrance as a function of thermal depth is plotted in FIG. 5E.

Using this example, the challenge can be seen of applying 3 Kwatt of power into a slot 81 mils×10 inches oriented 6 deg from vertical. The laser heater concepts of the disclosed embodiments are particularly beneficial for this task as compared to more conventional heating methods. For example, to provide this heat with an IR lamp, assume that an 0.081″×10″ surface is fitted to that opening and is radiating as a black body. Its temperature would have to be 3,130K in the example using the following relationship:

$${T}_{B B} = \sqrt[4]{\frac{{P}_{h}}{σ {W}_{y} {s}_{i}}}$$

Clearly this is not practical, as the IR emitter would ignite the part and the image at this high of a temperature. For analysis purposes, the required temperature can be determined or estimated for the hypothetical situation of using optics to relay the emission from a hot rectangle into the nip The available solid angle is approximately 2 θᵢ steradians, making the required temperature from the lossless system 7,240K as determined using the following relationship:

$${T}_{B B} = \sqrt[4]{\frac{{P}_{h} π}{σ {W}_{y} {s}_{i} {θ}_{i}}}$$

The required black body temperature of an IR lamp plotted as a function of thermal depth is shown in FIG. 5F. Note that a heated depth of 8 mils as shown in the plot corresponds to the temperature of commonly used IR bulbs, and the power required is approximately 9 Kwatt, similar to observed bulb consumption. The thermal flux Ft going into that nip entrance is about 500 watt/cm² in this example and can be determined using the relationship:

$$Ft = \frac{{P}_{h}}{{W}_{y} {s}_{i}}$$

Two ways of moving that high of a quantity of thermal power include liquid metal convection and laser heating. Laser heating techniques are discussed further below.

Referring first to FIG. 6A, shown is an embodiment of transfusion assembly 20 from FIGS. 1, 4A and 4B. Portions of the transfusion assembly are omitted to better illustrate laser heat and control features. As illustrated, laser heater system 72 includes a laser 102 directing laser light toward nip entrance 130 between build surface 88 of part 26 and any layer 22 (not shown in FIG. 6A) on belt 24. Using optional temperature measurement and feedback components 106, laser control circuitry 104 controls the application of power to laser 102 to control optical energy emissions toward nip entrance 130.

FIGS. 6B and 6C are diagrammatic perspective and side views of a further example embodiment of the laser system 72 of transfusion assembly 20. In this example embodiment, the laser 202 of laser system 72 is a laser bar of side-by-side emitting lasers. For example, a typical 808 nm 100 watt laser bar is 10.9 mm wide. Shoulder to shoulder these devices produce 2,350 watts over 10 inches. One further example of such as laser bar is the 100 W 808 nm CW Water Cooled Single Bar Diode Laser product, which is commercially available from Hangzhou BrandNew Technology Company, having a fast axis divergence (FWHM) of 40 degrees. In the alternative, other laser diode bars are commercially available. For instance, a Coherent brand OnyxMCCP-9000-808 laser diode bar is available with a fast axis cylindrical lens which would drop the divergence to 6 degrees. Assuming the laser with the 40 degree fast axis divergence is used, and assuming that that the 40 deg fast axis divergence is out of the plane of the laser bar, since for safety it is preferable to have no focusing optics after the laser, this can require that the laser be 26 mils or less from the nip using the relationship:

$$\frac{{s}_{i}}{2 tan ( 40 deg )}$$

Laser 202 shown in FIGS. 6B and 6C includes, in an exemplary embodiment, a laser block 206 positioned between a cathode upper cover 204 and an anode lower cover 210. A water plenum 208 can also be positioned between the cathode 204 and the anode 210. The laser 202 of laser system 72 can also include a lower waveguide cover 212 and an upper waveguide cover 214 extending from the laser toward the nip opening 130. This allows the laser to heat the part build surface 88 (and optionally a layer 22) within a very small and closely controlled distance from nip entrance 130.

Alternatively, a laser 222 shown in FIG. 6D can be used in the laser system 72 in some embodiments of the transfusion assembly 20. Laser 222 includes a fast axis collimator (FAC) lens 224 followed by a focusing cylindrical lens 226. This allows the lenses and laser to be isolated with distance. Such a configuration, with the laser and lense positioned more distantly from the nip entrance, protects the optical surfaces from getting scratched and dirty. It also allows the laser light to approach the nip entrance and at a lower angle.

Nip entrance temperature is frequently seen as the best indicator and control variable for part strength built using selective layer deposition based additive manufacturing. The nip entrance temperature can be measured by imaging the infrared emission from the nip entrance onto a pyrometer or thermosensor array. In conventional practice, selective layer deposition based additive manufacturing is typically operated by strongly illuminating the nip entrance with 2,400 C bulbs. The stray and reflected light from those bulbs overwhelms thermal emission from the nip surfaces. As a result, a Lyre-style measurement (a multi-wired thermal sensor buried near the part surface) can in some instances be the only practical way to monitor the nip temperature.

The best practical IR bulb heaters are able to bring the part and image surfaces from 120 C to abut 210 C in about 0.4 seconds prior to arriving at the nip. Changing to laser heating, using for example 808 nm or 930 nm wavelengths, helps to achieve heating from 120 C to 280 C in 0.06 seconds prior to arriving at the nip. Further, laser heating will facilitate changing from carbon black to an infrared dye, allowing non-black parts. Laser heating will also allow switching the heat on and off in approximately 5 mseconds, constraining heat to just the part build surface. Laser heating will also provide collimated heating instead of isotropic heat, reducing anomalous edge heating. Laser heating further facilitates reducing the heat penetration depth from ˜20 mils to ˜4 mils, making it easier to subsequently cool the part build surface.

As discussed above with reference to FIG. 5C, a challenge with laser heating of the 0.5″ of image and part surface approaching the nip entrance is that the two surfaces form an increasingly acute angle. Referring again to the plot of FIG. 5D, with a targeted thermal diffusion length A of about 4 mils, the opening at the nip is about 240 mils, or 8 mm. The laser sheet thickness produced by the laser bars with their collimating cylindrical lenses is about 8 mm, therefore the laser needs to be steered so that it deposits the correct amount of energy below and above the line of the nip. Variations in part height can be +/−50 mils, or more than a millimeter. If the optical energy is improperly aligned such that more optical energy is imparted to the imaged layer than the part surface, the imaged layer will be substantially hotter than the part surface at the nip entrance, and vice versa.

In some disclosed embodiments such as described below with reference to FIGS. 9A and 9B, the relatively narrow bandwidth of the laser emission is used to distinguish the optical energy absorbed by the toner from the optical energy emitted by the toner. As shown in FIG. 9A, an embodiment of the transfusion assembly includes a laser bar array or arrays 322 which emit optical energy 324 toward the nip entrance 130. The nip entrance is shown between the build surface 88 of part 26 on build platform 28, nip roller 70, transfer belt 24 and a developed layer 22 on the belt coming into contact with the build surface. In some embodiments, laser steering mechanisms 320, such as linear or rotary actuators, steer or orient the laser bar arrays 322 or optical energy 324 using feedback to achieve substantially a same temperature of the imaged layer 22 and the part build surface 88. An imaging pyrometer sensor 328 is positioned to receive collected optical energy (e.g., IR) emissions from the nip entrance through a wavelength selective device 330, such as a silicon plate or window, and is used to provide feedback for controlling laser bar arrays 322 and/or laser steering mechanisms 320. One or more mounts 334 can optionally be included to point or orient the pyrometer toward the transfuse roller nip entrance heated by the laser light or by other radiant heater.

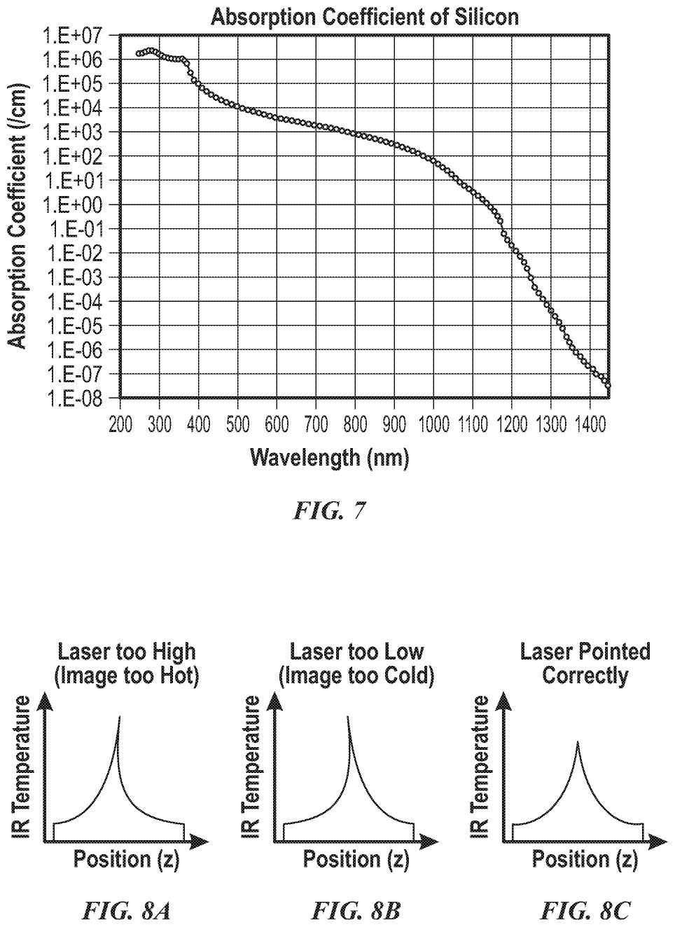

The laser light 324 has a typical bandwidth of around 5 nm so that no laser-generated light longer than 1 um is expected. By 2 um, the absorption coefficient has dropped about 10 orders of magnitude as can be seen in FIG. 7 which plots absorption coefficient as a function of wavelength for the example of silicon. A typical industrial pyrometer is sensitive to wavelengths from 8 um to 14 um. Inserting a wavelength selective device 330 between the nip and the pyrometer sensor 328 makes the sensor blind to the laser light, allowing the pyrometer to measure IR emissions indicative of a temperature at the nip entrance. Further, many sensors use visible-blind optics (like an amorphous silicon lens), so that the additional window is not necessary. Pyrometer sensor 328 is included, in some embodiments, with temperature measurement and feedback components 106 to provide temperature measurement feedback for use by laser control circuitry 104 in controlling the lasers of laser heating system 72, or for use in controlling laser steering mechanisms 320, to achieve the desired part and layer temperatures at the nip entrance.

Two side-by-side pyrometers, arranged to receive emissions indicative of the temperature of the part surface and the imaged layer, respectfully, can indicate whether the laser sheet is correctly oriented towards the nip. FIG. 9B illustrates an embodiment of the transfusion assembly 20, similar to the embodiment shown in FIG. 9A, but including two separate pyrometers 328-1 and 328-2. The two pyrometers can be side by side, but in FIG. 9B they are offset slightly from one another for ease of illustration. Dashed line 332-1 indicates that pyrometer 328-1 is oriented by mount(s) 334 to detect temperature indicative emissions from the part surface 88. Dashed line 332-2 indicates that pyrometer 328-2 is oriented by mount(s) 334 to detect temperature indicative emissions from the image layer 22. By comparing the temperatures derived by temperature measurement and feedback components 106 and controller 36 from the emissions sensed by the pyrometers, the laser orientation with laser steering mechanisms 320, the laser power duty cycle or other features can be controlled to achieve the desired heating orientation or control. FIGS. 8A-8C illustrate examples of the kinds of temperature distributions that a full imaging thermal camera might see taken across the nip, for different pointing errors of the laser.

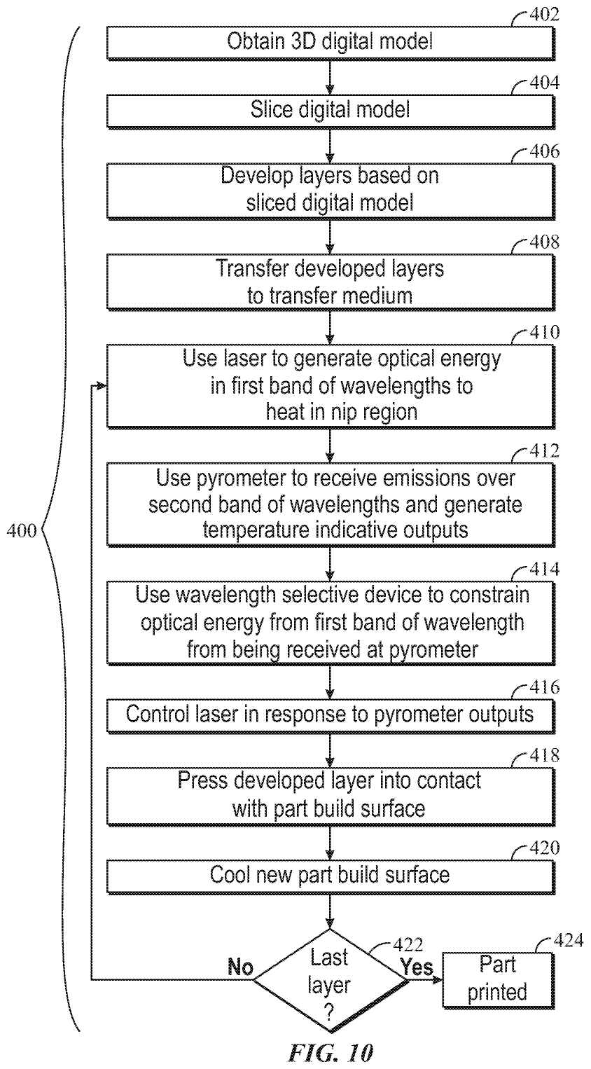

Referring now to FIG. 10, shown is one exemplary embodiment of a method 400 for printing a part using an electrophotographic (EP) additive manufacturing system in accordance with embodiments and concepts discussed above. Disclosed methods, such as shown in FIG. 10, are implemented for example in suitably configured or programmed controllers such as controllers 36 and/or 38 in exemplary systems. As shown at block 402, a digital model of the 3D part to be printed is obtained, and at block 404, the digital model is sliced. The digital model slices can then be stored on a computer readable medium and/or output for printing on an EP manufacturing system. While in some embodiments method 400 includes the activities shown in blocks 402 and 404, in other embodiments the activities of blocks 402 and 404 can be omitted and the method can instead begin with obtaining sliced digital model data.

At block 406, layers 22 of a powder material are developed using at least one EP engine 12. The developed layers are transferred, as shown at block 408, from the one or more EP engines to a transfer medium such as transfer belt 24. In some embodiments, the activities of blocks 410-420 are performed repeatedly for each of multiple developed layers to be transferred to a build surface 88 of the part 26. In other embodiments, the activity shown in some of these blocks (e.g., 410-414) are not performed for each developed layer, but are instead performed at less frequent intervals. FIG. 10 illustrates one example embodiment in which all of the activities of blocks 410-420 are performed for each of multiple developed layers. However, disclosed embodiments include methods where some of the activities are performed less frequently.

As shown at block 410, one or more lasers are used to generate optical energy emissions in a first band of wavelengths to heat are area of the part build surface 88 and/or layer 22 near the nip entrance. At block 412, at least one pyrometer is used to receive emissions over a second band of wavelengths, as described above, and to generate the temperature indicative outputs. As discussed, some embodiments include at least two pyrometers oriented to collect emissions from the part build surface and from the developed layer such that the outputs or corresponding temperatures can be compared. As discussed, method 400 also includes using a wavelength selective device to constrain optical energy from the first band of wavelengths from being received at the one or more pyrometers. This is shown at block 414. As shown at block 416, the one or more lasers are then controlled in response to the pyrometer outputs. The control can be such that the part build surface 88 and the developed image layer 22 are heated to approximately the same temperature.

It is noted that, while FIG. 10 illustrates control of the one or more lasers such that the part build surface 88 and the developed image layer 22 are heated to approximately the same temperature for each of multiple developed layer to be transferred, in some embodiments the laser control adjustments are made based upon the measured temperature and these adjustments are used for each of multiple developed layers. In other words, the laser control may involve a one-time or occasional adjustment, and may not require a quick response closed-loop feedback control to readjust for each layer. The laser control (e.g., orientation, intensity, power duty cycle, etc.) can be substantially constant through a part build in some embodiments. Also, in yet other embodiments, with systems allowing measurement of both the part build surface and image temperatures at the nip, laser control adjustments can be made to vary with image layer thickness, with transfuse roller temperature, with image pre-heat temperature, or with other factors. However, these factors are frequently fairly constant through a build.

Next, as shown at block 418, the heated developed layer on the transfer medium is pressed into contact with the heated part build surface to place the part build surface into intimate contact with the developed layer. This consolidates the two and forms a new part build surface. At block 420, the new part build surface is cooled to remove the heat energy added by the laser. At decision point 422, a determination is made as to whether the last developed layer has been deposited. If the last layer has been deposited, then as shown at bock 424 the part is printed. If the last layer has not been deposited, previously discussed activities can be repeated for the next developed layer. By repeating these activities for each layer to be transfused to the part build surface, the part is built in a layer-by-layer manner.

Although the present disclosure has been described with reference to preferred embodiments, workers skilled in the art will recognize that changes may be made in form and detail without departing from the spirit and scope of the disclosure.

What is claimed is:

1. A selective layer deposition additive manufacturing system for printing a three-dimensional part, the additive manufacturing system comprising:
an electrostatographic imaging engine configured to develop an imaged layer of a thermoplastic-based powder;
a movable build platform configured to support a 3D part having a part build surface;
a transfer medium configured to receive the imaged layer from the imaging engine, and to convey the received imaged layer;
a transfuse roller transfusion element configured to transfer the imaged layer conveyed by the transfer medium onto the movable build platform by pressing the imaged layer between the transfer medium and the part build surface, the transfuse roller having a nip;
at least one optical energy emitter configured to utilize emissions in a first band of wavelengths to apply optical energy in a region proximate the transfuse roller nip;
at least one pyrometer configured to receive emissions from a surface in the region proximate the transfuse roller nip over a second band of wavelengths, distinct from the first band of wavelengths, and to convert the received emissions over the second band of wavelengths into temperature indicative outputs;
a wavelength selective device positioned between the at least one pyrometer and the transfuse roller nip and configured to allow optical energy within the second band of wavelengths to be transmitted from the region proximate the transfuse roller nip to the at least one pyrometer while constraining optical energy within the first band of wavelengths from being received by the pyrometer; and
a controller configured to control the at least optical energy emitter responsive to the temperature indicative outputs of the at least one pyrometer.

2. The additive manufacturing system of claim 1, wherein the at least one optical energy emitter comprises at least one laser.

3. The additive manufacturing system of claim 2, wherein the at least one laser transmits optical energy in the first band of wavelengths to apply optical energy to the part build surface and imaged layer in the region proximate the transfuse roller nip.

4. The additive manufacturing system of claim 3, and further comprising a mount coupled to the at least one pyrometer and configured to orient the at least one pyrometer toward the transfuse roller nip.

5. The additive manufacturing system of claim 3, wherein the at least one pyrometer includes a first pyrometer and a second pyrometer each configured to convert received emissions into temperature indicative outputs, the first pyrometer oriented to receive emissions from the part build surface and the second pyrometer oriented to receive emissions from the imaged layer.

6. The additive manufacturing system of claim 5, wherein the controller is configured to control the at least one laser based upon a comparison of the temperature indicative outputs from the first and second pyrometers.

7. The additive manufacturing system of claim 2, and further comprising at least one laser steering mechanism coupled to the at least one laser and configured to steer the at least one laser under the control of the controller to heat the imaged layer and the part build surface to approximately the same temperature.

8. The additive manufacturing system of claim 2, wherein the at least one laser includes at least one laser bar.

9. The additive manufacturing system of claim 2, wherein the controller is configured to control the at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part.

10. The additive manufacturing system of claim 9, wherein the controller is configured to control the at least one laser to heat the part build surface the distance xₕ before the transfuse nip roller, where the distance xₕ is determined using the relationship:
$${x}_{h} = \frac{{v}_{b} {λ}_{z}^{2}}{{κ}_{p}} .$$

11. The additive manufacturing system of claim 2, and further comprising:
a fast axis collimator lens positioned between the laser and the transfuse nip roller; and
a cylindrical lens positioned between the fast axis collimator lens and the transfuse nip roller.

12. A selective layer deposition additive manufacturing system for printing a three-dimensional part, the additive manufacturing system comprising:
an electrostatographic imaging engine configured to develop an imaged layer of a thermoplastic-based powder;
a movable build platform configured to support a 3D part having a part build surface;
a transfer medium configured to receive the imaged layer from the imaging engine, and to convey the received imaged layer;
a transfuse roller transfusion element configured to transfer the imaged layer conveyed by the transfer medium onto the movable build platform by pressing the imaged layer between the transfer medium and the part build surface, the transfuse roller having a nip;
at least one laser configured to utilize emissions in a first band of wavelengths to apply optical energy in a region proximate the transfuse roller nip; and
a controller configured to control the at least one laser to heat the part build surface and imaged layer in the region proximate the transfuse roller nip.

13. The additive manufacturing system of claim 12, wherein the controller is configured to control optical energy output of the at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part.

14. The additive manufacturing system of claim 13, wherein the controller is configured to control the optical energy output of the at least one laser to heat the part build surface the distance xₕ before the transfuse nip roller, where the distance xₕ is determined using the relationship:
$${x}_{h} = \frac{{v}_{b} {λ}_{z}^{2}}{{κ}_{p}} .$$

15. The additive manufacturing system of claim 12, and further comprising:
a fast axis collimator lens positioned between the at least one laser and the transfuse nip roller; and
a cylindrical lens positioned between the fast axis collimator lens and the transfuse nip roller.

16. The additive manufacturing system of claim 12, and further comprising:
at least one pyrometer configured to receive emissions from a surface in the region proximate the transfuse roller nip over a second band of wavelengths, distinct from the first band of wavelengths, and to convert the received emissions over the second band of wavelengths into temperature indicative outputs;
a wavelength selective device positioned between the at least one pyrometer and the transfuse roller nip and configured to allow optical energy within the second band of wavelengths to be transmitted from the region proximate the transfuse roller nip to the at least one pyrometer while constraining optical energy within the first band of wavelengths from being received by the pyrometer; and
wherein the controller is configured to control the at least one laser as a function of the temperature indicative outputs from the at least one pyrometer.

17. The additive manufacturing system of claim 16, wherein the at least one pyrometer includes a first pyrometer and a second pyrometer each configured to convert received emissions into temperature indicative outputs, the first pyrometer oriented to receive emissions from the part build surface and the second pyrometer oriented to receive emissions from the imaged layer, wherein the controller is configured to control the at least one laser based upon a comparison of the temperature indicative outputs from the first and second pyrometers.

18. A method for printing a 3D part with a selective layer deposition based additive manufacturing system, the method comprising:
developing layers of a powder material using at least one electrostatographic engine;
transferring the developed layers from the at least one electrostatographic engine to a transfer medium;
using at least one laser to generate optical energy in a first band of wavelengths to apply optical energy in a region proximate a transfuse roller nip;
using at least one pyrometer to receive emissions from a surface in the region proximate the transfuse roller nip over a second band of wavelengths, distinct from the first band of wavelengths, and to convert the received emissions over the second band of wavelengths into temperature indicative outputs;
using a wavelength selective device positioned between the at least one pyrometer and the transfuse roller nip to allow optical energy within the second band of wavelengths to be transmitted from the region proximate the transfuse roller nip to the at least one pyrometer while constraining optical energy within the first band of wavelengths from being received by the pyrometer;
controlling the at least one laser responsive to the temperature indicative outputs of the at least one pyrometer; and
using the transfuse roller to press the developed layers on the transfer medium into contact with the part build surface to form a new part build surface.

19. The method of claim 18, wherein using the at least one pyrometer to receive emissions from the surface in the region proximate the transfuse roller nip over the second band of wavelengths further comprises using a first pyrometer oriented to receive emissions from the part build surface and a second pyrometer oriented to receive emissions from a developed layer on the transfer medium, and wherein controlling the at least one laser responsive to the temperature indicative outputs of the at least one pyrometer further comprises controlling the at least one laser based upon a comparison of the temperature indicative outputs from the first and second pyrometers.

20. The method of claim 18, wherein controlling the at least one laser responsive to the temperature indicative outputs of the at least one pyrometer further comprises controlling the at least one laser to heat the part build surface a distance xₕ before the transfuse nip roller, where the distance xₕ is a function of a desired thermal diffusion depth λ_{z}, a speed v_{b} of the moveable build platform, and a thermal diffusivity Kₚ of the 3D part, where the distance xₕ is determined using the relationship:
$${x}_{h} = \frac{{v}_{b} {λ}_{z}^{2}}{{κ}_{p}} .$$
